(19) United States
(12) Patent Application Publication
(10) Pub. No.: US 2012/0004137 A1
(43) Pub. Date: Jan. 5, 2012

(54) IDENTIFICATION OF NUCLEIC ACID DELIVERY VEHICLES USING DNA DISPLAY

(75) Inventors: Richard W. Wagner, Cambridge, MA (US); Yan Chen, Lexington, MA (US); Steven Mark Shamah, Acton, MA (US)

(73) Assignee: X-Body, Inc., Waltham, MA (US)

(21) Appl. No.: 13/147,898

(22) PCT Filed: Feb. 16, 2010
(86) PCT No.: PCT/US10/24296

§ 371 Date: Sep. 22, 2011

Related U.S. Application Data
(60) Provisional application No. 61/152,403, filed on Feb. 13, 2009.
(60) Provisional application No. 61/225,664, filed on Jul. 15, 2009.

(51) Int. Cl. C40B 30/06; C40B 40/06

(52) U.S. Cl. 506/10; 506/16

(57) ABSTRACT

The present invention features methods and compositions for the identification of molecules that facilitate the intracellular delivery of a, e.g., nucleic acid molecule. The methods and compositions of the invention utilize any display methodology wherein a library (e.g., a small molecule or protein library) is coupled to a nucleic acid (e.g., RNA or DNA) that encodes each library member.

### BACKGROUND OF THE INVENTION

Efficient cytoplasmic delivery remains a key challenge for nucleic acid therapeutic development. Targeted delivery of nucleic acids into a cell can be achieved by conjugating nucleic acids to ligands (e.g., antibodies, antibody fragments, antibody mimetics, peptides, or small molecules) that bind to and are internalized by cell surface molecules. Standard display technologies utilize target binding as the selective pressure to drive the directed evolution process, such that members of a ligand library that bind to the target with highest affinity have a selective advantage to persist and become enriched under increasingly stringent selection conditions. In some cases, however, the highest affinity binders to a target are not necessarily the most functionally relevant library members. For example, those library members that can readily enter the cell and access the cytoplasm are likely to be the most effective as targeting vehicles for nucleic acid delivery.

Thus, there exists a need for a display technology that utilizes cytoplasmic entry to directly select for ligands conjugated to nucleic acids that can enter the cell and access the cytoplasm, irrespective of the mechanism of internalization.

### SUMMARY OF THE INVENTION

The present invention features methods and compositions for the identification of molecules that facilitate the intracellular delivery of, e.g., a nucleic acid molecule. The methods and compositions of the invention utilize any display methodology wherein a library (e.g., a small molecule or protein library) is coupled to a nucleic acid (e.g., RNA or DNA) that encodes or tags each library member.

Accordingly, in a first embodiment, the invention features a composition that includes a nucleic acid display library, wherein members of the nucleic acid display library are linked to a molecule that generates an intracellular readout signal. In another embodiment, the invention features a composition that includes a nucleic acid display library, wherein members of the nucleic acid display library are linked to a streptavidin molecule and the streptavidin molecule is additionally linked to a molecule that generates an intracellular readout signal. In either embodiment, the molecule that generates an intracellular readout signal may be, for example, a nucleic acid (e.g., a reporter gene, a transcription factor gene, a RNA, or an antisense gene), a protein (e.g., green fluorescent protein (GFP)), a peptide, or a small molecule (e.g., a fluorophore). Nucleic acid molecules of the nucleic acid display libraries of the compositions described herein may be expressed intracellularly under the control of an exogenous polymerase (e.g., T7 RNA polymerase) promoter.

In another embodiment, the invention features a composition that includes a DNA-encoded small molecule library with multimeric small molecule species attached to members of the library via a branched linker.

Also provided by the present invention is a composition that includes a DNA-encoded small molecule library with two or more small molecules (e.g., two, three, four, five, six, seven, eight, nine, ten, or more small molecules) attached to the DNA of the library through the DNA bases, wherein the DNA bases are modified with a linker species.

In a further embodiment, the invention features a method for the identification of a molecule that facilitates the intracellular delivery of a nucleic acid, wherein the molecule is linked to a member of a nucleic acid display library and the member of the nucleic acid library is further linked to a gene. In this method, cells are contacted with the nucleic acid display library and members of the nucleic acid display library linked to a molecule that facilitates the delivery of the nucleic acid into the cells are identified by monitoring expression of the gene linked to a member of the nucleic acid library. In one aspect, the expression of the gene linked to a member of the nucleic acid library is under the control of an exogenous RNA polymerase promoter, and the cells express RNA polymerase (e.g., T7 RNA polymerase) in the cell's cytoplasm. In another aspect, cells express one or more enzymes (e.g., DNA methyltransferase) capable of modifying members of the nucleic acid library that are delivered intracellularly.

The invention also features a method for the identification of a molecule that facilitates the intracellular delivery of a nucleic acid, wherein the molecule is linked to a member of a nucleic acid display library and the member of the nucleic acid library is further linked to a RNA polymerase binding site. In this method, cells are contacted with the nucleic acid display library and a member of the nucleic acid display library linked to a molecule that facilitates the delivery of the nucleic acid into the cells is identified by monitoring and decoding intracellular transcription of a nucleic acid portion of members of the nucleic acid library. In the case where the encoding library is dsDNA derived, RNA polymerase (e.g., T7 RNA polymerase) present in the cell catalyzes transcription. In another example where the library is ssRNA, RNA dependent RNA polymerase present in the cell catalyzes transcription (e.g., polioviral 3Dpol, vesicular stomatitis virus L, and hepatitis C virus NS5b protein); alternatively, reverse transcriptase present in the cell catalyzes DNA polymerization. In another embodiment, where the library is ssDNA, ssDNA-dependent RNA polymerase present in the cell catalyzes transcription (e.g., N4 bacteriophage ssDNA dependent RNA polymerase). ssDNA-dependent DNA polymerases also exist which could be used in the invention for libraries consisting of ssDNA.

In the methods described above, the molecule that facilitates intracellular delivery of a nucleic acid may be a nucleic acid molecule (e.g., RNAi, miRNA, an antisense nucleic acid molecule, or a gene). Alternatively, the molecule may be a protein, peptide, or small molecule.

In a further embodiment, the invention features a method for the identification of a first molecule that facilitates the intracellular delivery of a second molecule, wherein the first and second molecules are linked to a member of a nucleic acid library. The method includes contacting cells with the nucleic acid display library and identifying members of the nucleic acid display library linked to the first molecule that facilitate the delivery of the second molecule into the cells by monitoring the modification of members of the nucleic acid library by one or more enzymes present in the cell. In this embodiment, the first or second molecule is a nucleic acid molecule (e.g., RNAi, miRNA, an antisense nucleic acid molecule, or a gene), a protein, a peptide, or a small molecule.

In any of the embodiments described herein, the nucleic acid display library may be a dsDNA display library (e.g., CIS display library, a puromycin-mediated dsDNA display library, a CDT display library, dsDNA libraries attached to small molecules, and streptavidin display libraries).

By “fluorophore” is meant a component or functional group of a molecule that causes a molecule to be fluorescent. Exemplary fluorophores include fluorescein, green fluorescent protein (GFP), yellow fluorescent protein (YFP), Alexa Fluor dyes, Cy dyes (GE Healthcare), nucleic acid probes (e.g., DAPI, ethidium bromide, acridine orange, or propidium iodide), hydroxycoumarin, aminocoumarin, emthoxycoumarin, rhodamine, BODIPY-FL, Texas Red, or TRITC.

By “linker” is meant a molecule that links the nucleic acid portion of the library to the functional displayed species. Such linkers are known in the art, and those that can be used during library synthesis include, but are not limited to, 5′-β-Dimethoxytrityl-1′,2′-Dideoxyribose-3′-[(2-cyanoethyl)-(N,N-diisopropyl)]-phosphoramidite; 9-O-Dimethoxytrityl-triethylene glycol, 1-[(2-cyanoethyl)-(N,N-diisopropyl)]-phosphoramidite; 3(4-4′-Dimethoxytrityloxy)propyl-1-[(2-cyanoethyl)-(N,N-diisopropyl)]-phosphoramidite; and 18-O-Dimethoxytritylhexaethyleneglycol, 1-[(2-cyanoethyl)-(N,N-diisopropyl)]-phosphoramidite. Such linkers can be added in tandem to one another in different combinations to generate linkers of different desired lengths. By “branched linker” is meant a molecule that links the nucleic acid position of the library to 2 or more identical, functional species of the library. Branched linkers are well known in the art and examples can consist of symmetric or asymmetric doublers (1) and (2) or a symmetric trebler (3). See, for example, Newcome et al., Dendritic Molecules: Concepts, Synthesis, Perspectives, VCH Publishers (1996); Boussif et al., Proc. Natl. Acad. Sci. USA 92: 7297-7301 (1995); and Jansen et al., Science 266: 1226 (1994).

By “nucleic acid display library” is meant a display technique used for in vitro protein, and/or peptide evolution, and/or small molecule, and/or nucleic acid evolution (e.g., ssRNA or ssDNA) discovery to create molecules that can bind to a desired target. In the case of proteins and peptides, including modified peptides, the process results in translated peptides or proteins that are associated with their mRNA progenitor or dsDNA via a puromycin linkage. In some cases of nucleic display, the protein or peptide is associated with mRNA, ssDNA, or dsDNA via a protein that covalently or non-covalently associates with the nucleic acid. In the case of small molecule display, the nucleic acid is covalently joined with the small molecule. In the case of nucleic acid display, randomized regions of ssRNA or ssDNA are used directly. The nucleic acid library complex then binds to an immobilized target in a selection step (e.g., affinity chromatography). The nucleic acid conjugates that bind well are then recovered and amplified via a polymerase chain reaction. The end result is a nucleotide sequence that encodes a binding molecule with desired properties (e.g., affinity or specificity) for the molecule of interest. A nucleic acid display library may include a dsDNA display library. Exemplary dsDNA display libraries include CIS dsDNA display libraries, puromycin-mediated dsDNA display libraries, CDT dsDNA display libraries, dsDNA libraries attached to small molecules, and streptavidin dsDNA display libraries. See, e.g., Odegrip et al., Proc. Natl. Acad. Sci. USA 101: 2806-2810 (2004); Kurz et al., Chembiochem. 2: 666-672 (2001); Fitzgerald, Drug Discov. Today 5: 253-258 (2000); and Clark et al., Nat. Chem. Biol. 5: 647-654 (2009).

By “nucleic acid” is meant a macromolecule composed of monomeric nucleotides (e.g., 5 or more nucleotides). Nucleic acids include deoxyribonucleic acid (DNA) (e.g., cDNA, mtDNA, and double-stranded DNA (dsDNA)) and ribonucleic acid (RNA) (e.g., miRNA, siRNA, snRNA, snoRNA, shRNA, RNAi, and mRNA). Nucleic acids may be double-stranded, single-stranded, or isolated (e.g., partially purified, essentially pure, synthetic, recombinantly produced). Nucleic acids may be altered by the addition, deletion, substitution, and/or alteration of one or more nucleotides. Such alterations can include the addition of non-nucleotide material, such as to the end(s) of the nucleic acid or internally (at one or more nucleotides). Nucleotides in the nucleic acid molecules of the present invention can also include non-standard nucleotides, including non-naturally occurring nucleotides.

By “protein,” “polypeptide,” “polypeptide fragment,” or “peptide” is meant any chain of two or more amino acids, regardless of post-translational modification (e.g., glycosylation or phosphorylation), constituting all or part of a naturally occurring polypeptide or peptide, or constituting a non-naturally occurring polypeptide or peptide.

By “small molecule” is meant a molecule that has a molecular weight below about 1000 Daltons. Small molecules may be organic or inorganic, and may be isolated from, e.g., compound libraries or natural sources, or may be obtained by derivatization of known compounds.

Other features and advantages of the invention will be apparent from the following detailed description, the drawings, the examples, and the claims.

### BRIEF DESCRIPTION OF THE DRAWINGS

FIG. 1 is a schematic showing that an exemplary library is generated such that two or more of the chemical molecules are attached to the nucleic acid portion of the library (e.g., as a dendrimer display) using a multifunctional linker moiety.

FIG. 2 is a schematic showing that an exemplary library is generated such that two or more of the chemical molecules are attached to both strands of the nucleic acid portion of the library using a multifunctional linker moiety.

FIG. 3 is a schematic showing streptavidin (tetramer) bound to the nucleic acid library and also bound to an expression gene or to dsRNAi.

FIG. 4 is a schematic showing a representation of a T7 expression vector.

FIG. 5 is a schematic describing a transient transfection assay for the detection of cytoplasmic T7 activity.

FIG. 6 is a schematic showing the components of a PCR fragment containing the T7 promoter upstream of the coding region of a V_{H} antibody domain.

FIG. 7 is a Western blot and RT-PCR assay showing that T7 RNA polymerase (RNAP) is active in transiently transfected HEK293T cells. Cell lysates were resolved by SDS-PAGE and subjected to Western blot analysis with a monoclonal antibody against T7 polymerase. The anti-T7 polymerase antibody recognizes a band that is consistent with the protein's predicted molecular weight (−99 kDa). The RT-PCR assay indicates that the V_{H} PCR template is transcribed by T7 polymerase in HEK293T cells. Control lanes indicate that RT-PCR activity is dependent upon expression of T7 polymerase and only occurs in the presence of templates containing the T7 polymerase promoter.

FIG. 8 is a RT-PCR assay testing the sensitivity of the T7 polymerase RT-PCR assay by titrating in the amount of V_{H} PCR template into transient transfections.

FIG. 9 is a RT-PCR assay showing that T7 RNAP is active in transiently transfected VCaP prostate cancer cells.

FIG. 10 is a RT-PCR assay showing the detection of T7 RNAP transcripts from stable prostate carcinoma cell lines.

FIG. 11 is a RT-PCR assay showing that the 22rV1_T7 cell line expresses active T7 polymerase.

FIG. 12 is a schematic showing the assembly of a complex of biotinylated peptide or V_{H} binder with streptavidin.

FIG. 13 is a schematic showing the transient transfection of assembled V_{H} or peptide complexes, or an assembly lacking a biotinylated peptide or protein, into HEK293T cells.

FIG. 14 is an assay showing the delivery of streptavidin assemblies into HEK293T cells transfected with T7 RNAP.

FIG. 15A is a schematic of the synthesis of a peptide-dsDNA construct. The V_{H} clone was PCR-amplified to append a BsmI site at the 5′-end upstream of the T7 promoter. Following restriction digestion and purification, the construct was ligated to HP-1-DTAF-R7 (headpiece modified with DTAF and (-Arg-εAhx)₆-Arg peptide). FIG. 15B is an electrophoretic gel of the ligation reaction (Lanes 1 and 2: different HP-1 samples ligated to V_{H}; Lane 3: unligated V_{H} PCR product; M: marker). FIG. 15C is a gel showing validation for T7 promoter activity. The gel shows a T7 Megascript (Ambion) reaction using samples from Lanes 1-3 of FIG. 15B.

FIG. 16 is an assay showing the internalization and transcription of a peptide-template conjugate by T7 RNAP in HEK293T cells.

FIG. 17 is a schematic illustrating a siRNA-mediated cytoplasmic entry selection strategy.

### DETAILED DESCRIPTION OF THE INVENTION

The present invention features methods for the identification of molecules that deliver nucleic acids into cells.

The compositions and methods of the present invention utilize nucleic acid aptamer libraries or any display methodology, wherein a library (e.g., a small molecule or protein library) is coupled to, e.g., a nucleic acid (e.g., RNA or DNA) that encodes each library member (e.g., via genotype-phenotype linkages or via covalent or non-covalent interactions). See, e.g., Lipovsek et al., J. Immunol. Methods 290: 51-67 (2004); Bertschinger et al., Protein Eng. Des. Sel. 17: 699-707 (2004); Yonezawa et al., Nucleic Acids Res. 31: e118 (2003); Tabuchi et al., FEBS Lett. 508: 309-312 (2001); Odegrip et al., Proc. Natl. Acad. Sci. USA 101: 2806-2810 (2004); and Fujita et al., J. Med. Chem. 45: 1598-1606 (2002). In one embodiment, the RNA or DNA is additionally linked to a molecule that generates an intracellular readout signal, e.g., a fluorophore, an RNAi molecule targeting a critical gene, a dsDNA sequence that encodes and can express an RNAi molecule or an antisense sequence, a dsDNA sequence that can express a reporter gene (e.g., GFP), a dsDNA sequence that binds a protein (e.g., a polymerase, a transcription factor, or a repressor), a small molecule, or a dsDNA that can express a protein or peptide that generates an intracellular readout.

Cells may be contacted with the library of the present invention. Members of the library linked to a molecule (e.g., a small molecule or peptide) that facilitates the delivery of a desired molecule (e.g., a nucleic acid molecule) into a cell may, for example, endocytose into the cell. Members of the nucleic acid library that remain bound to the cell surface are stripped by, e.g., ionic strength, pH, detergent, or protease treatment. Cells may then be lysed, and the internalized material subjected to amplification (e.g., PCR) to identify the molecule that facilitates delivery.

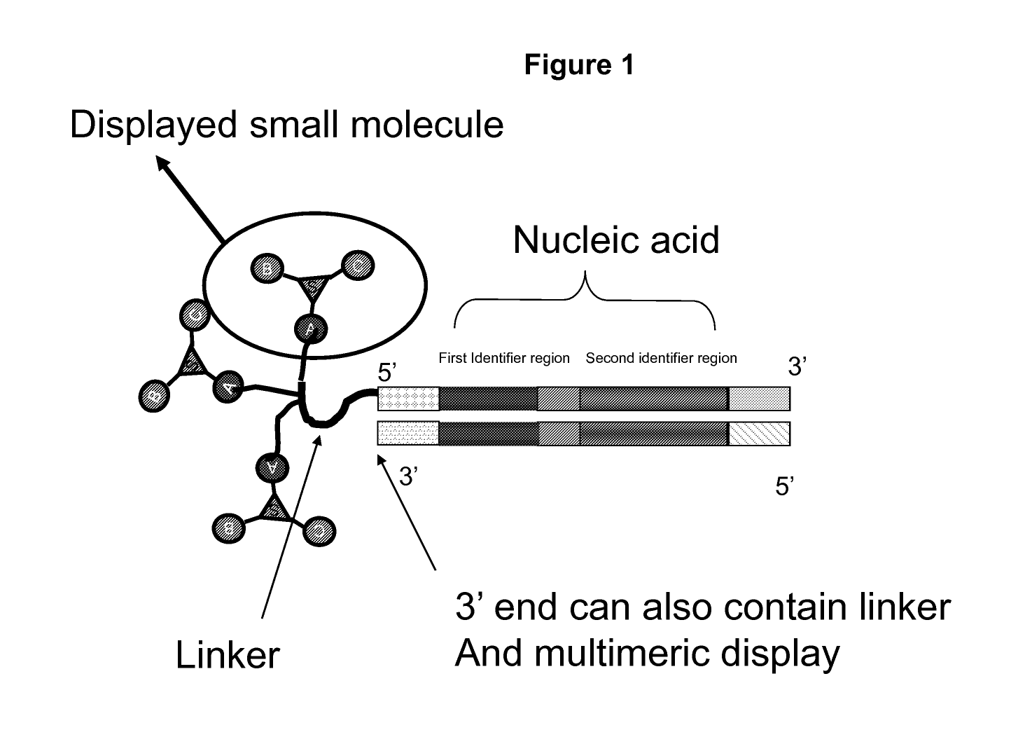

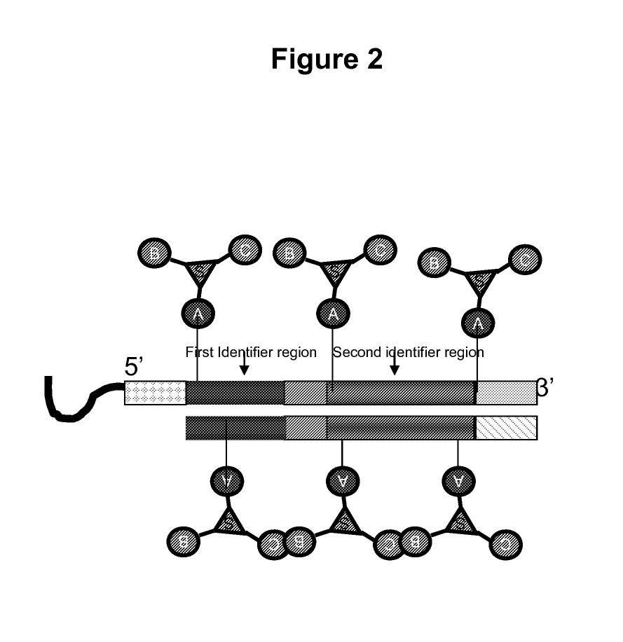

The library may be generated such that two, three, four, or more chemical molecules are attached (e.g., as a dendrimer display) to a member of the nucleic acid display library using a linker moiety (e.g., a multifunctional linker moiety) (FIG. 1). This approach may be used, for example, to trigger multiple receptors on the cell and cause internalization. In other methods that use monomeric species, receptors may not internalize efficiently, leading to very low or non-existent signal. Thus, one library design of the present invention (e.g., small molecules attached to DNA) is generated with a linker that is attached to a DNA identifier region on one end and multiple amines (or other reactive species) on the other end of the linker. The multiple amines or other reactive species are used to generate and attach multiple copies of the synthesized small molecule on the DNA. In one embodiment, both strands can display the small molecule (FIG. 2). Alternatively, amines, or other molecules that are easily functionalized with library synthesis, can be incorporated singly or in multimers along multiple positions of the identifier region through the C5 position of, e.g., uridine or cytosine, such that multiple small molecules can be displayed along the length of the DNA molecule of a member of a nucleic acid display library. Both strands of DNA can be modified. In addition, the bases in the DNA can be modified to enhance cell entry, including addition of hydrophobic residues (e.g. 5-methyl C, C5 alkyl substitutions, C5 alkynyl substitutions, etc.).

A library consisting of protein or peptide domains (e.g., the V_{H} domain of an antibody) is created such that the domains are linked via nucleic acid display methods (e.g., mRNA display, streptavidin display, covalent DNA display, noncovalent DNA display, etc.). The nucleic acid encodes the protein or peptide-binding domain, and also encodes, e.g., a reporter gene (e.g., GFP), an RNAi gene (e.g., hnRNAi), a transcription factor, or a transcription factor binding site. In one example, a library of V_{H} domains attached to the gene for GFP is contacted with cells, cells expressing GFP are isolated, and the identity of the V_{H} domain is determined by PCR and sequencing. Using this method, specific V_{H} binders that deliver dsDNA to cells can be identified as novel delivery vehicles.

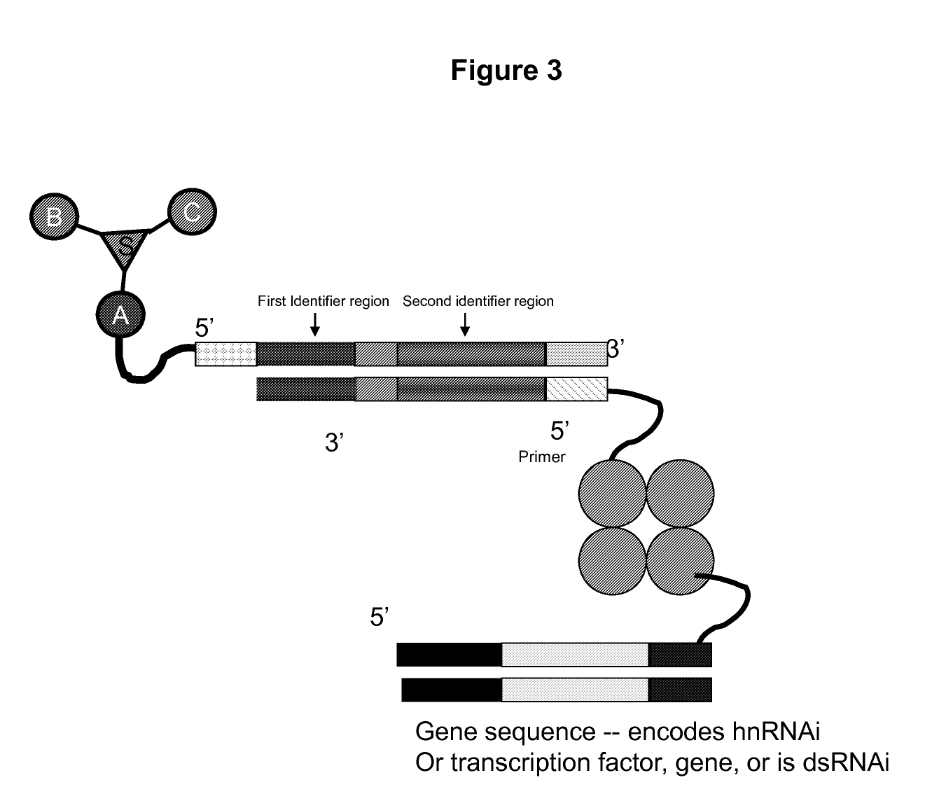

In another embodiment, streptavidin is bound to the nucleic acid library (e.g., the nucleic acid contains a biotin molecule and binds to the streptavidin through a biotin binding site) and is also bound to an expression gene (e.g., the expression gene contains a biotin and binds the streptavidin through a second biotin binding site, as streptavidin is tetrameric) or to dsRNAi (e.g., the dsRNAi contains a biotin and binds the streptavidin through a second biotin binding site) (FIG. 3).

The invention additionally features a general method for the identification of novel molecules that deliver nucleic acid, or other payloads (e.g., small molecules or peptides), into cells. The method utilizes a display methodology where either a small molecule library or protein library is coupled to dsDNA that encodes each library member (e.g., via genotype-phenotype linkages or via covalent or non-covalent interactions) and further contains an RNA polymerase promoter region (for example, T7 RNA polymerase). The library is subsequently incubated with cells expressing the appropriate RNA polymerase in the cytoplasm. Subsequently, a library member, localized in the cytoplasm of the cell, can be transcribed by the RNA polymerase. The cells are then lysed, and RNA is isolated and subjected to RT-PCR to identify the dsDNA present in the cytoplasm. The identification of the dsDNA subsequently identifies the molecule that was attached to the dsDNA that mediated the delivery into the cell.

Delivery of nucleic acids into cells remains one of the key challenges for therapeutic development of this class of molecules, whether by means of an antisense, miRNA, RNAi, or gene therapy approach. One significant hurdle in the discovery of delivery agents is the ability to detect rare events that result in the release of nucleic acid into the cell. Ideally, one would like to be able to detect release of single molecules in cells, but this requires an ultra-sensitive readout system. Once single-molecule delivery is achieved, the delivery method can then be further optimized.

dsDNA affords single-molecule detection in cells by means of amplification by polymerases. For example, microinjection of individual molecules of dsDNA into the cell nucleus, even as a linear restriction enzyme-digested fragment harboring a gene of interest, results in the transcription and translation of the gene as detected by immunofluorescence staining of the expressed protein. In contrast, microinjection of dsDNA into the cytoplasm rarely results in gene expression, even when introduced at high concentration. Cytoplasmic expression of dsDNA can be achieved, however, using cells that express T7 RNA polymerase, which localizes in the cytoplasm.

Several methods exist for the coupling of small molecules, peptides, or proteins to dsDNA as displayed libraries. In general, an encoding relationship exists between the genotype (dsDNA) and displayed molecule such that a determination of the sequence of the genotype leads to the identification of the displayed molecule. Described herein are methods for identifying mediators of delivery of molecules to cells using novel selection technology together with display libraries.

In one particular embodiment for identifying proteins or small molecules that mediate intracellular delivery of nucleic acids, dsDNA-displayed libraries containing an RNA polymerase binding site are incubated with cells expressing RNA polymerase in the cytoplasm. Following incubation, the cells are lysed and subjected to RT-PCR to amplify any RNA transcripts that emerged from dsDNA-library members that were delivered into the cytoplasm.

In another embodiment, a small molecule or peptide library screening approach is utilized wherein non-tagged molecules are screened with the dsDNA library to search for facilitators of delivery. In this embodiment, dsDNA-displayed libraries containing an RNA polymerase binding site are incubated with cells expressing RNA polymerase in the cytoplasm. Subsequently, small molecules or peptides are added to the cells to facilitate the release of the dsDNA molecules.

In yet another embodiment, dsDNA containing an RNA polymerase binding site, without any displayed small molecule, peptide, or protein, is incubated with cells expressing RNA polymerase in the cytoplasm. Subsequently, small molecules or peptides are added to the cells to facilitate the release of dsDNA molecules. The aforementioned method can be used in a high throughput screening mode to identify facilitators of dsDNA delivery to cells.

In yet another embodiment, the dsDNA in the library is added to cells that express dsDNA methyltransferase. Once the library member enters the cell, any intracellular dsDNA is methylated, recovered, and subjected to methylation specific PCR.

Cytoplasmic localization of bacteriophage T7 RNA polymerase (T7 RNAP) in mammalian cells is described, for example, in Elroy-Stein and Moss; Proc. Natl. Acad. Sci. USA 87: 6743-6747 (1990) and Wang et al., Analytical Biochem. 375: 97-104 (2008), hereby incorporated by reference.

Using the methods described herein, general reagents that mediate tissue or cell delivery can be identified that potentially have broad delivery properties; for example (but not limited to) any form of nucleic acid, protein, peptide, small molecule, liposome, or nanoparticle.

### EXAMPLES

The following examples are intended to illustrate the invention. They are not meant to limit the invention in any way.

### Example 1

### Construction of T7 RNA Polymerase Cell Line

The bacteriophage T7 RNA polymerase (RNAP) was amplified from BL21 cells using the following PCR primers (NcoI site in bold; start ATG in italics; Kozak sequence underlined; NotI site in lowercase lettering; tandem stop codons (TTATTA) in italics):

5-T7RNAPOL-pEF:
(SEQ ID NO: 1)
TACTCATGCCATGGCCACCATGAACACGATTAACATCGCTAAGA
3-T7RNAPOL-STOP2:
(SEQ ID NO: 2)
ATGATACgcggccgcTTATTACGCGAACGCGAAGTCCGA

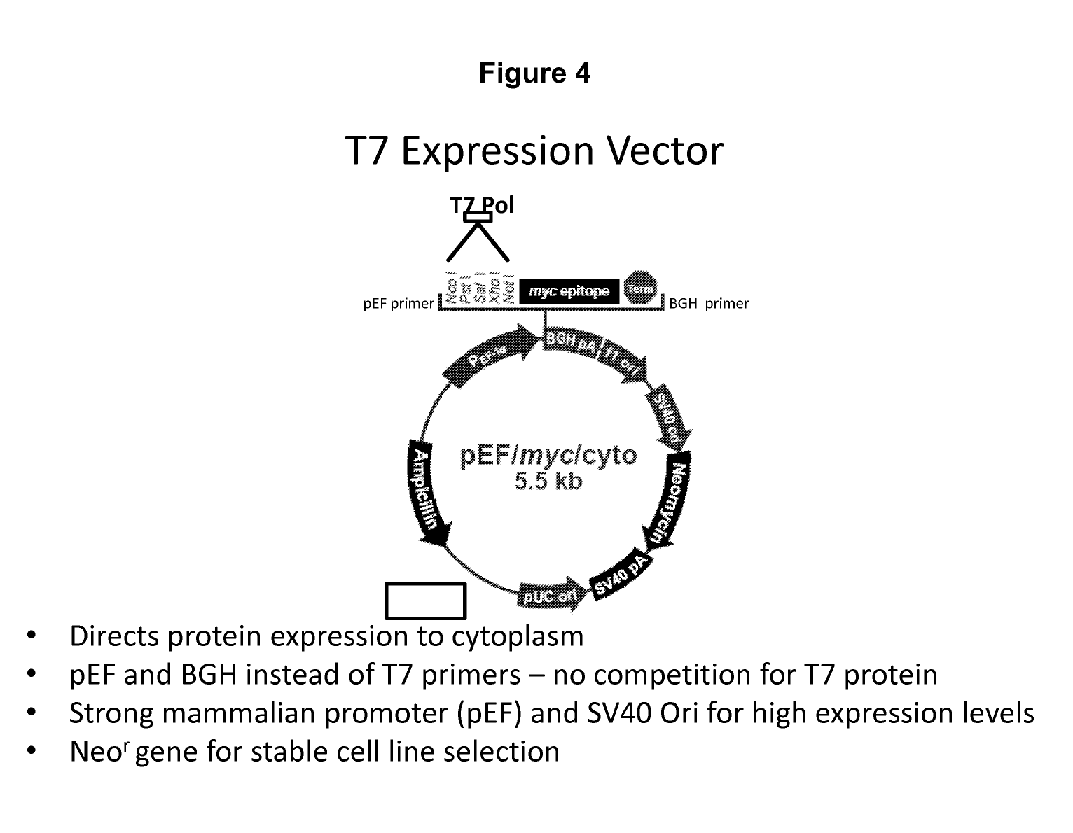

The amplified gene product was directionally cloned as an NcoI/NotI fragment into the pEF/myc/cyto expression vector (Invitrogen #V890-20) (FIG. 4). This vector is designed for cytoplasmic expression with a strong EF-1a promoter and a neomycin resistance gene for stable cell line selection. The vector lacks the T7 promoter commonly found upstream of multiple cloning site polylinkers, thereby eliminating the possibility of competing promoter activity once the T7 RNAP is expressed.

### Example 2

### Activity of T7 RNAP in Transiently Transfected HEK293T Cells

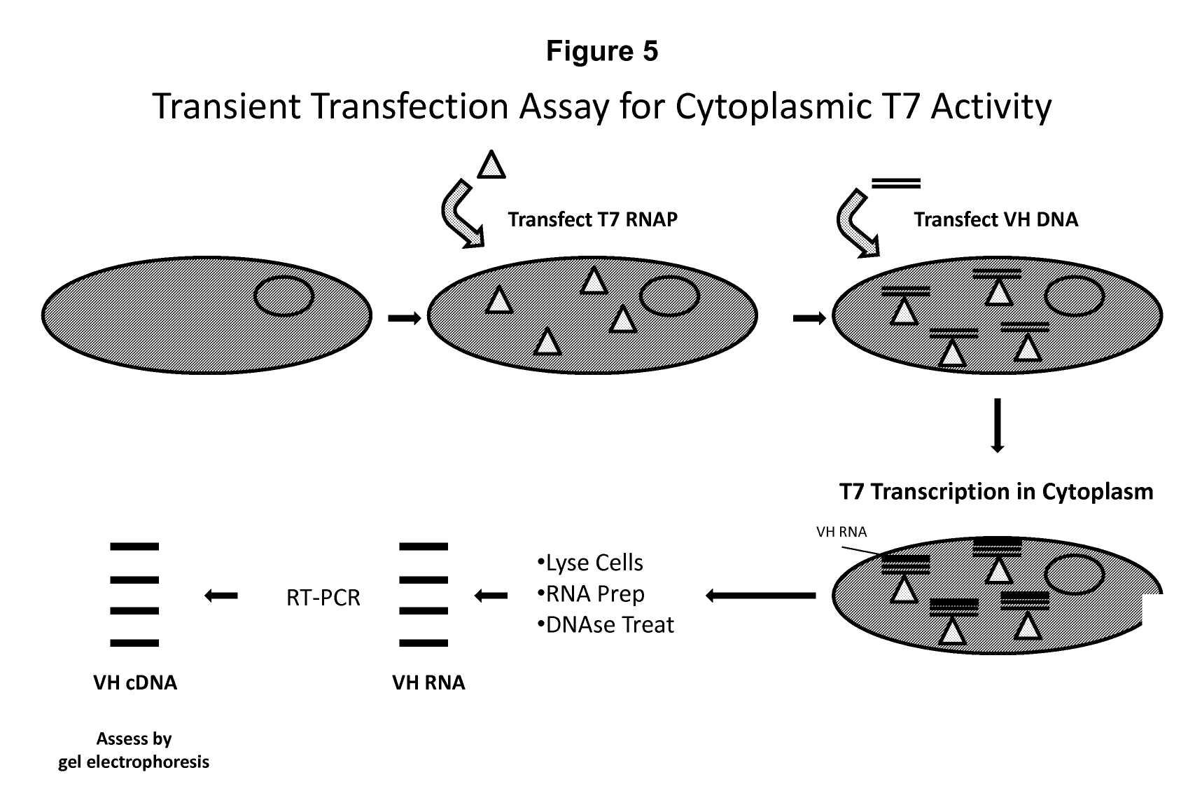

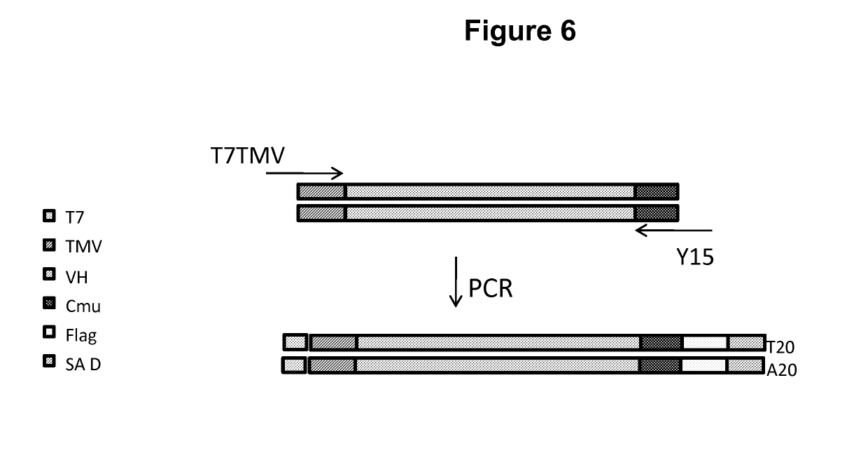

To determine if cytoplasmic T7 would be active as a polymerase in mammalian cells, we developed a transient transfection assay in HEK293T cells (FIG. 5). Cells were seeded in 24-well dishes at 350,000 cells/well and then incubated overnight in Eagle's Minimum Essential Medium supplemented with 10% fetal bovine serum (FBS). A DNA template containing the T7 promoter upstream of the coding region of a V_{H} antibody domain was prepared by PCR as follows. V_{H} DNA from a naïve human V_{H} library was PCR amplified (Strategene 600312) with a 5′ oligo coding for in vitro transcription and translation signal T7TMV (5′-TAATACG ACTCACTATAGGGACAATTACTATTTACAATTACA-3′; SEQ ID NO: 3)) and a 3′ oligo annealing to the C-terminal V_{H} DNA Cmu and SA linker region, Y15 (5′-TTTTTTTTTTTTTTTTTTTTAAATAGCGGATGCCTTGTCGTCGTCGTCCTTG TAGTCGGTTGGGGCGGATGCACTCCC-3′; SEQ ID NO: 4). The PCR product was gel purified. The components of the PCR fragment are summarized in FIG. 6. When the V_{H} DNA fragment is transfected into cells expressing T7 RNA polymerase, T7 RNAP loads on the DNA and transcribes the DNA into RNA. This specific RNA is then detected and amplified by RT-PCR.

Cells were transfected with a combination of 300 fmol T7 DNA template and 2.5 μg T7 expression construct along with control samples transfected with: no template+2.5 μg T7_pEF/myc/cyto vector; 300 fmol T7 DNA template+2.5 μg pEF/myc/cyto vector; or no template+2.5 μg pEF/myc/cyto vector. Cells were transfected using Lipofectamine 2000 (Invitrogen) according to manufacturer's protocol (2 μl Lipofectamine/transfection). Cells were incubated overnight and then RNA prepared from lysed cells for analysis by RT-PCR. To test the T7 RNAP activity, a specific and sensitive RT-PCR assay was developed. Cytoplasmic RNA was prepared from the cell lysates collected from the experiments using RNeasy Mini Kit (Qiagen 74104). Briefly, the cell lysate was spun down to remove insoluble proteins. The cleared lysate was mixed with buffer RLT containing guanidine salt and ethanol and added to a binding column. The column was washed with RW1 buffer. DNase treatment was performed on the column with an RNase-free DNase kit (Qiagen 79254) to remove the carryover DNA. The column was further washed with RPE buffer, 70% ethanol, and dried. RNA was eluted with 30 μl of nuclease-free water. To thoroughly remove the DNA from the RNA samples for downstream PCR, RNA elute was digested with 10 units of DNase I at 37° C. for 1 hour (Ambion AM2222). The RNA was then purified with an RNeasy MiniElute Cleanup Kit (Qiagen 74204) following the manufacturer's recommended protocol and eluted in 20 μl of H₂O. Reverse transcription was performed using Superscript II Reverse Transcriptase (Invitrogen 18064-014). Briefly, a mixture of 10 μl of RNA, 10 nmol of each dNTP, and 5 μmol of V_{H}-specific 3′ Cmu oligo (5′-GGTTGGGGCGGATGCA CTCCC-3′; SEQ ID NO: 5) was incubated at 65° C. for 5 minutes and chilled to 4° C. to reduce the secondary structure of RNA and primer annealing. 5× first strand cDNA synthesis buffer, 0.1 M DTT (10×), and 200 units of reverse transcriptase were added to a final volume of 20 μl. The reaction was incubated at 42° C. for 50 minutes and heat-inactivated at 70° C. for 15 minutes. One μl of first strand cDNA was amplified in the presence of Herculase buffer, 200 μM dNTP, 0.2 μM T7TMV, S6-1 (5′-TTAAAT AGCGGATGCTAAGGACGACTTGTCGTCGTCGTCCTTGTAGTCGGTTGGGG CGGATGCACTCCC-3′; SEQ ID NO: 6) oligos and 1.25 units of Herculase (Strategene 600312) in a 25 μl volume for 15-25 cycles. The PCR products were viewed on 2% agarose gels (Invitrogen G5018-02).

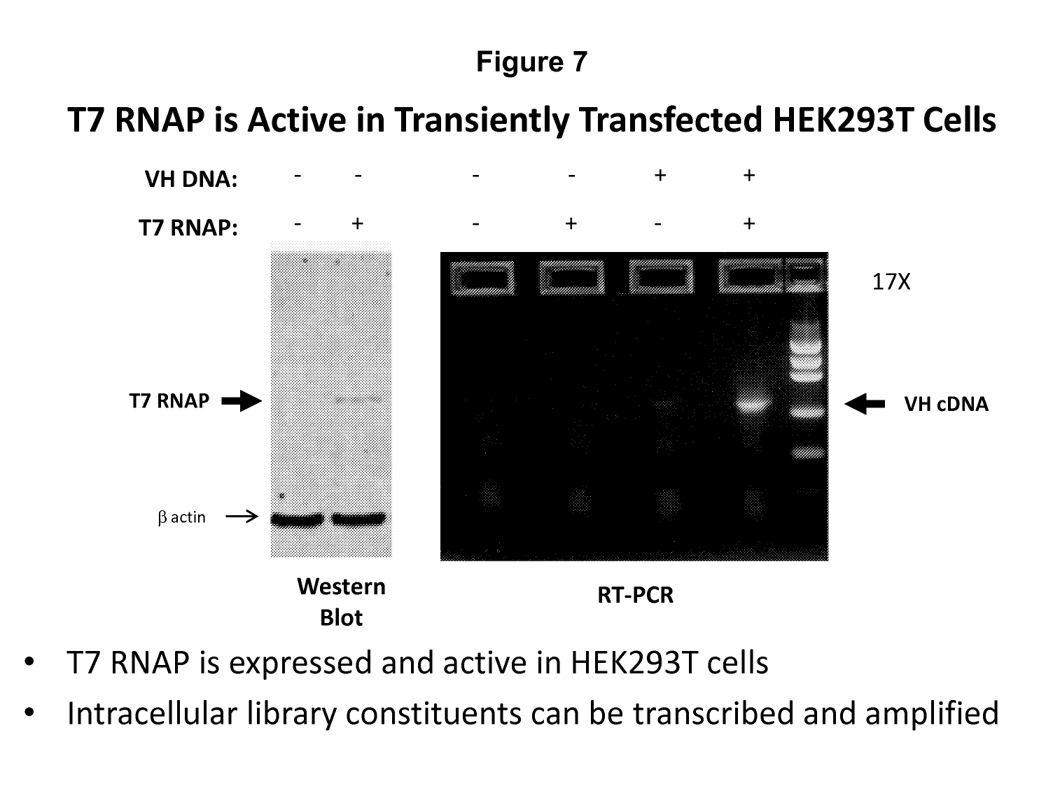

To confirm T7 polymerase expression, parallel wells were transfected as above and lysed in an NP-40 detergent cell lysis buffer. Cell lysates were resolved by SDS-PAGE and subjected to Western blot analysis with a monoclonal antibody against T7 polymerase (EMD Bioscience #70566-3). The anti-T7 polymerase antibody recognizes a band that is consistent with the protein's predicted molecular weight (˜99 kDa) (FIG. 7). The RT-PCR assay indicated that the V_{H} PCR template is transcribed by T7 polymerase in HEK293T cells. Control lanes indicated that the RT-PCR activity is dependent upon expression of T7 polymerase and only occurs in the presence of templates containing the T7 polymerase promoter (FIG. 7).

### Example 3

### Sensitivity of T7 RNAP in Transiently Transfected HEK293T Cells

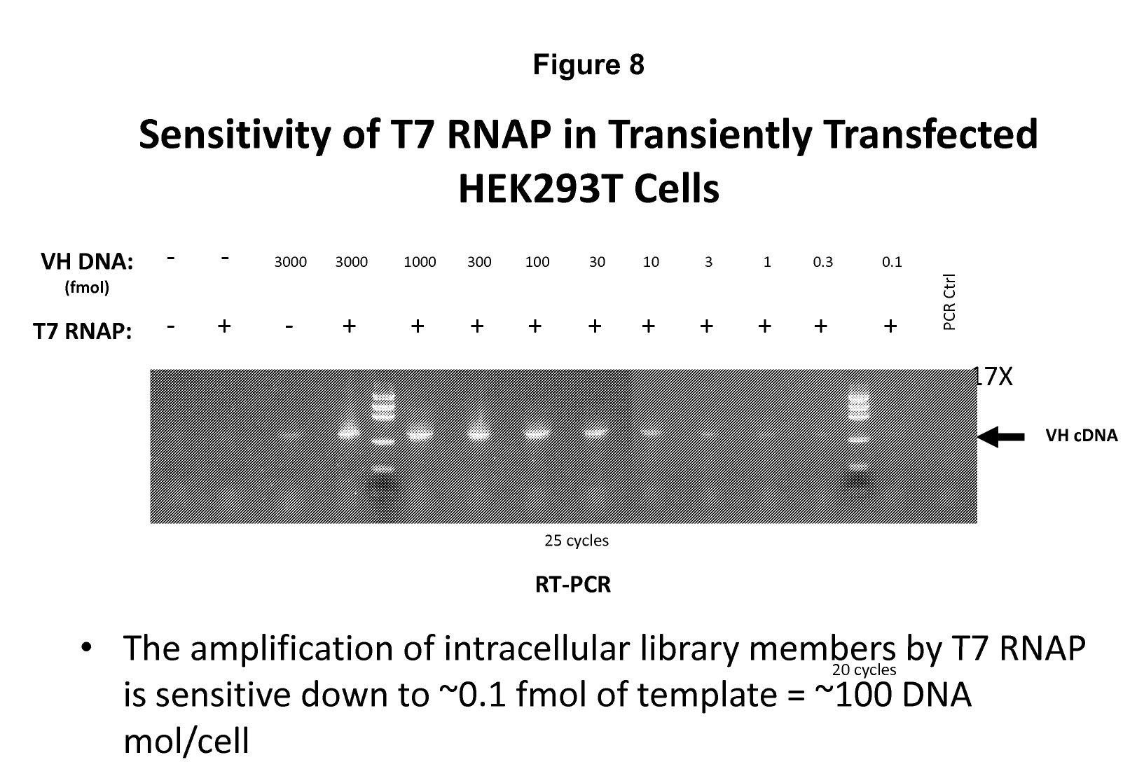

Since starting libraries for selections are vastly diverse (up to ˜10¹⁴ different sequences present), the capture and amplification of library members that access the cytoplasm must be of extraordinary sensitivity. We have tested the sensitivity of the T7 polymerase RT-PCR assay by titrating in the amount of V_{H} PCR template into the transient transfections. Following the transfection protocol outlined above, V_{H} PCR template ranging from 3 pmol/sample to 0.1 fmol/sample was co-transfected with the T7_pEF/myc/cyto expression construct. RT-PCR of recovered samples indicates that even 0.1 fmol of template per cell can be transcribed by cytoplasmic T7 polymerase and amplified to detectable levels (FIG. 8).

### Example 4

### Activity of T7 RNAP in Transiently Transfected VCaP prostate Cancer Cells

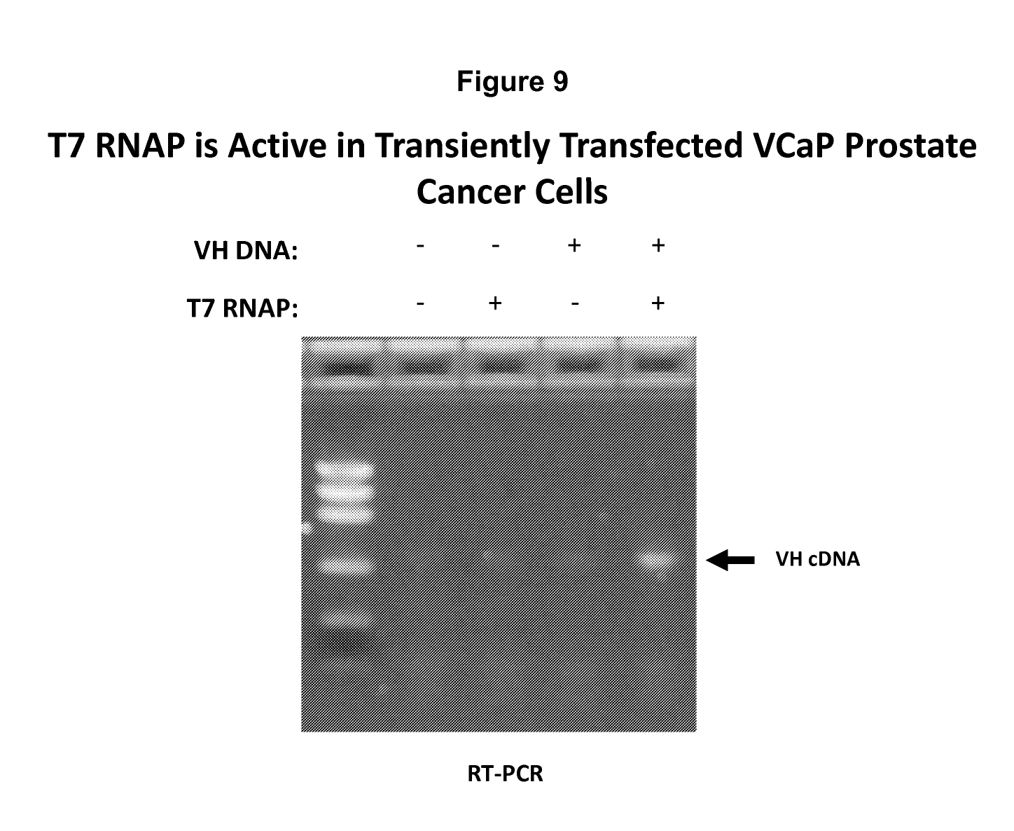

The goal of the present invention is to establish a platform that enables cytoplasmic uptake selections in a variety of cell types. Recently, several groups have engineered siRNA conjugates to reagents that target prostate-specific membrane antigen on prostate carcinoma cells and have successfully demonstrated mRNA knockdown via targeted delivery. See, e.g., Chu et al., Nucleic Acids Res. 34: e73 (2006); McNamara et al., Nat. Biotechnol. 24: 1005-1015 (2006), Dassie et al., Nat. Biotechnol. 27: 839-846 (2009). Thus, we have extended our proof-of-concept studies to examine the activity of cytoplasmic T7 polymerase in a variety of prostate carcinoma cell lines. VCaP cells are prostate carcinoma cells that express prostate-specific membrane antigen (PSMA) on the cell surface. Transient transfection of VCaP cells with the T7 pEF/myc/cyto expression construct and V_{H} PCR template revealed that T7 polymerase possesses transcriptional activity in the cytoplasm of these cells with the same T7 and template-dependency, as observed in transiently transfected HEK293T cells (FIG. 9).

### Example 5

### Detection of T7 RNAP transcripts from stable prostate carcinoma Cell Lines

To further test the T7 polymerase RT-PCR assay, we have established other prostate carcinoma cell lines stably selected for T7 polymerase expression by drug resistance to neomycin using the T7_pEF/myc/cyto construct. PC3 and DU-145 cells are prostate carcinoma cell lines that lack expression of PSMA, whereas LnCap and 22rV1 are prostate carcinoma cell lines that express PSMA. All four cell types were transfected with either T7_pEF/myc/cyto or the pEF/myc/cyto empty vector and selected for growth in the presence of 750 μg/ml neomycin (Geneticin, Gibco).

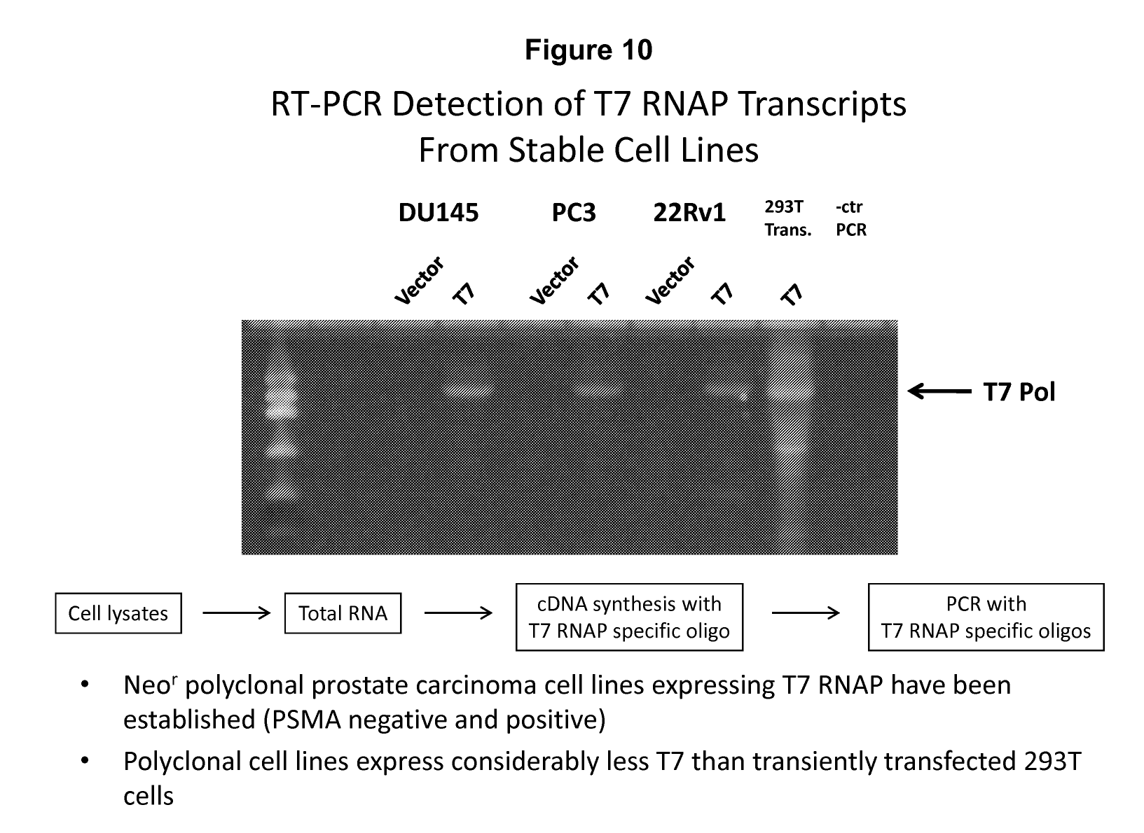

Neomycin-resistant cells were pooled and assayed for T7 expression by RT-PCR. Approximately 10×10⁶ cells were harvested and lysed and RNA was isolated with RNeasy Mini Kit (Qiagen 74104) as described above. T7 RNAP transcripts were detected by using a 3′ T7 RNAP-specific oligo (ATGATACGCGGCCGCTTATTA CGCGAACGCGAAGTCCGA; SEQ ID NO: 7) for the RT reaction and a 5′ T7 RNAP-specific oligo (TACTCATGCCATGGCCACCATGAACACGATTAACAT CGCTAAGA; SEQ ID NO: 8) and the same 3′ oligo for PCR amplification. Only the cells stably drug-selected by transfection with the T7_pEF/myc/cyto construct reveal a cDNA band consistent in size with the amplified region of T7 polymerase (FIG. 10). For comparison, equal amounts of total RNA from HEK293T cells transiently transfected with the T7_pEF/myc/cyto construct were subjected to RT-PCR with the same T7-specific oligos. The data indicates that the stable T7 prostate carcinoma cell lines express less T7 polymerase than that found in transiently transfected HEK293T cells (FIG. 10).

### Example 6

### Activity of T7 RNAP in PSMA-Expressing Carcinoma Cell Line

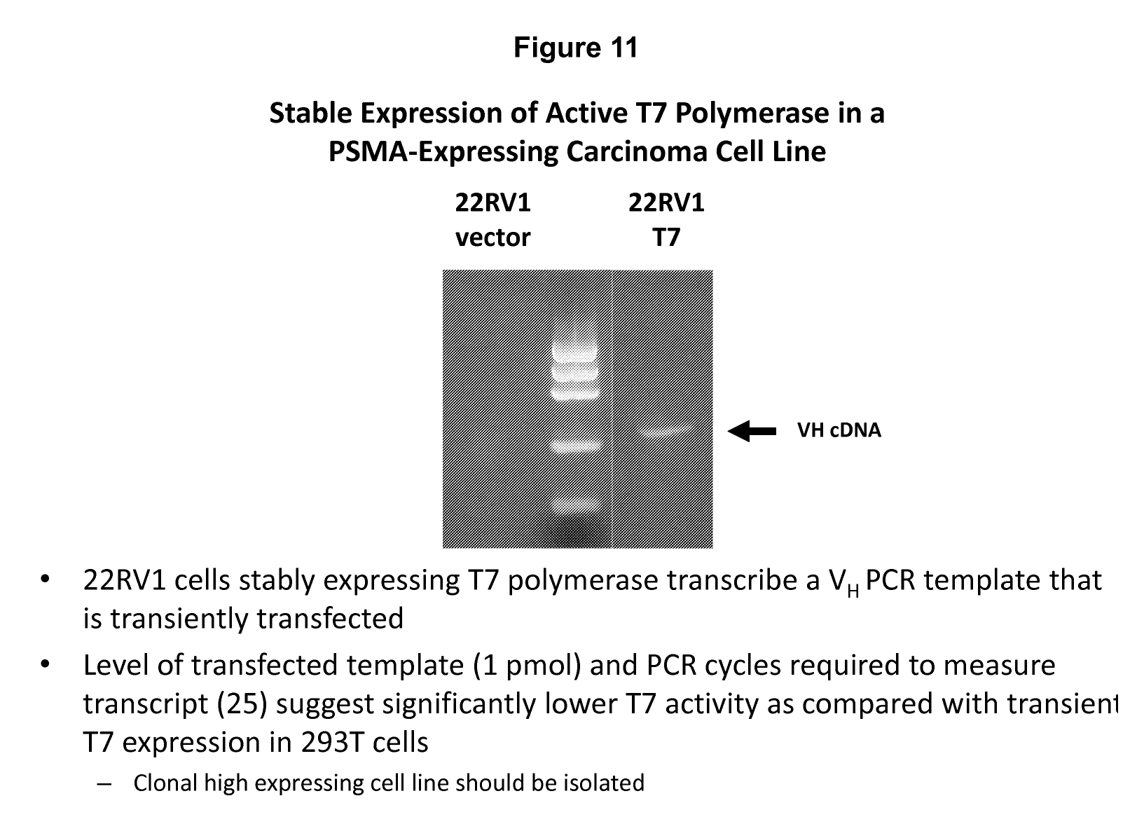

To determine if T7 polymerase expressed in cells that have undergone stable drug-selection is active, we established a modified RT-PCR assay. The assay is similar to that described above with the exception that the first transfection to express T7 transiently is eliminated, given the stable T7 expression already present. Instead, V_{H} PCR product is transfected into prostate carcinoma cell lines with or without stable expression of T7 and the RT-PCR assay is carried out as described above. FIG. 11 shows that the 22rV1_T7 cell line expresses active T7 polymerase, as indicated by the presence of V_{H} cDNA. In contrast, the negative control cell line (22rV1_Vector) shows no T7-dependent RT-PCR activity.

### Example 7

### Cytoplasmic T7 Polymerase Activity on Biotin-Streptavidin Assemblies

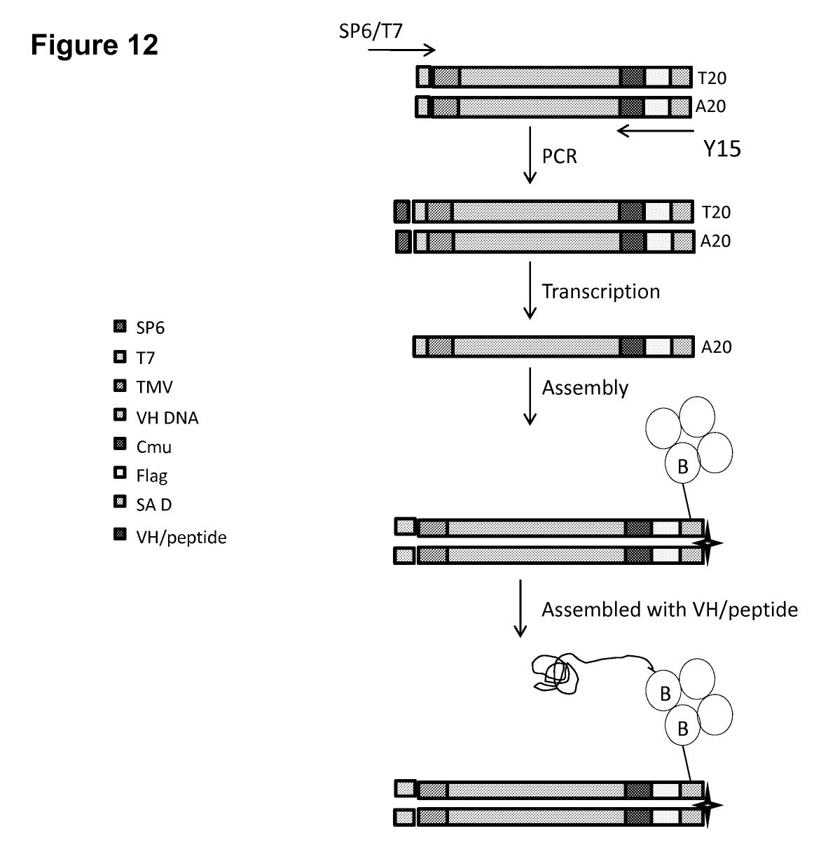

For the cytoplasmic entry selections to be successful, biotin-streptavidin assemblies of oligonucleotide and encoded peptide or protein must be competent as T7 polymerase templates. To test whether a complex of biotinylated peptide or V_{H} binder assembled with streptavidin can be transfected into cells, transcribed by T7 RNAP, and detected by RT-PCR, the above V_{H} DNA was modified to carry both SP6 and T7 promoter sequences at the 5′ end (5′-ATTTAGGTGACACTATAGAAGA GTAATACGACTCACTATAGGGACAATTATATTTACAATTACA-3′; SEQ ID NO: 9) and Cmu-flag-SA-polyA sequence at the 3′ end (FIG. 12). The DNA was then in vitro transcribed into RNA with an SP6 transcription kit (Ambion AM1330). The RNA was purified by RNAeasy MiniElute Cleanup Kit (Qiagen 74204). A biotinylated RNA/DNA linker for SA display was annealed to RNA at 1:1 ratio and UV-crosslinked to RNA template. Streptavidin was loaded onto the ligated RNA by interacting with biotin on the linker at 1:1 molar ratio. The assembly complex was then subjected to oligo dT purification. The assembly complex bound to oligo dT through the RNA polyA tail and free SA was washed off. Reverse transcription was performed on oligo dT cellulose using the ligated DNA linker as the primer and extended with superscript II (Invitrogen 18064-014) for 1 hour at 37° C. The RNA and first strand cDNA hybrid was then digested with RNaseH (Invitrogen 18021-014) for 1 hour to cleave the RNA strand. The first strand DNA in solution was recovered by centrifugation of the oligo dT cellulose. Second strand DNA was synthesized with the SP6T7 oligo as primer and extended with superscript II (Invitrogen 18021-014). A biotinylated molecule, V_{H} or peptide, was then incubated with the dsDNA-SA complex at a 2:1 molar ratio to generate the dsDNA-SA-V_{H} or dsDNA-SA-peptide (FIG. 12).

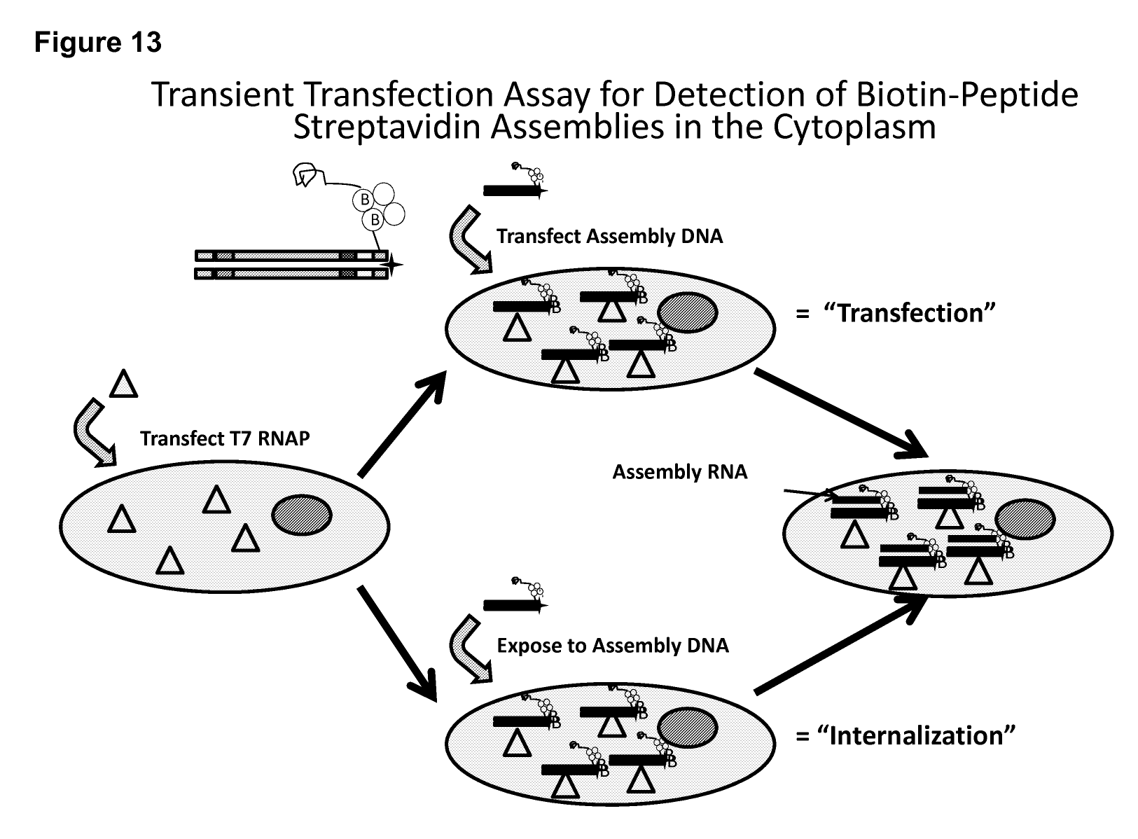

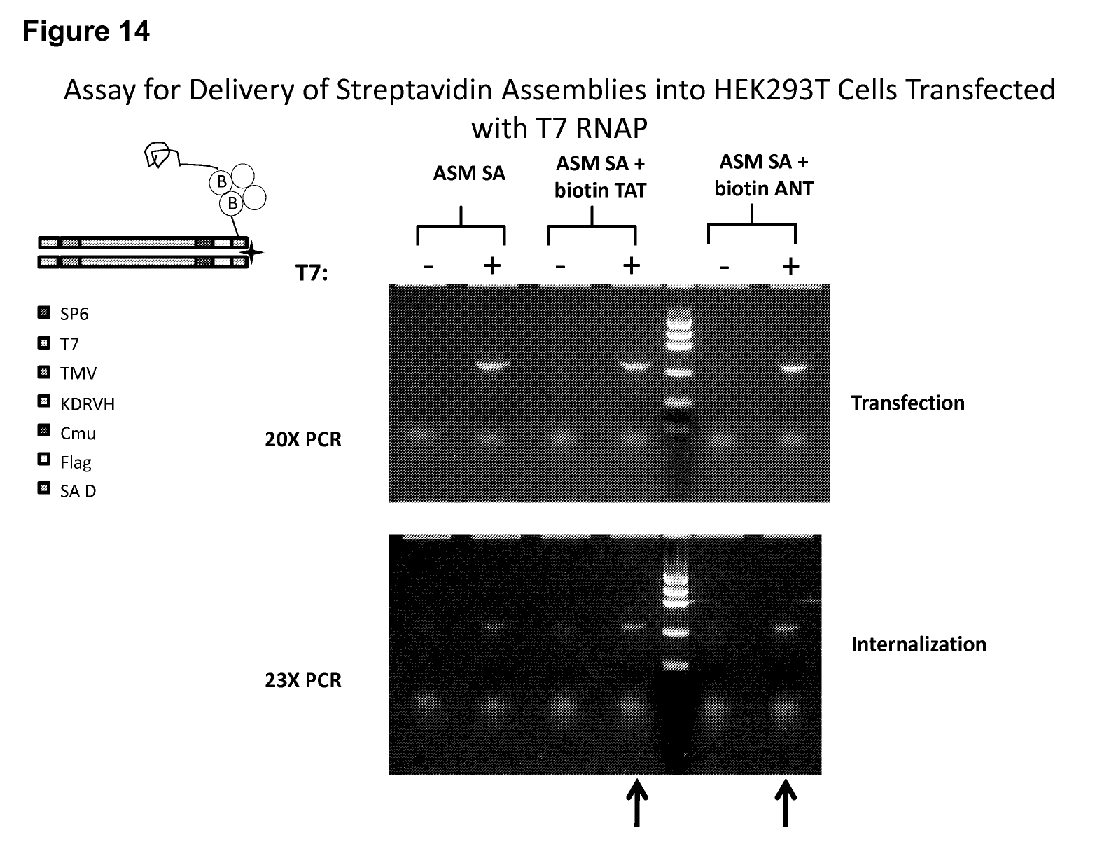

For proof-of-concept studies two different peptides that have previously been described as cell penetrating peptides (CPPs) were tested: the TAT peptide (Biotin-YGRKKRRQRRR; Anaspec; SEQ ID NO: 10) and the Antennapedia peptide (Biotin-KKWKMRRNQFWVKVQRG; Pi Proteomics; ANT; SEQ ID NO: 11). Assembled V_{H} or peptide complexes, or an assembly lacking a biotinylated peptide or protein, were transiently transfected into HEK293T cells and assayed for RT-PCR in cells that had been co-transfected with T7 polymerase, as outlined in FIG. 13. The results confirm that oligonucleotides that have been assembled with peptides or VH proteins via the biotin:streptavidin coupling strategy utilized in our libraries can be transcribed by cytoplasmic T7 polymerase (FIG. 14, top panel). Thus, the cytoplasmic T7 polymerase system can be utilized as a selective pressure for entry into the cytoplasm during cell-based selections.

To further validate the selection strategy, we sought to demonstrate T7 polymerase activity due to transfection-independent cytoplasmic entry. Since the TAT and ANT peptides have been previously identified as CPPs, biotin:streptavidin assemblies with these peptides might also be able to enter the cytoplasm and act as templates for cytoplasmic T7 polymerase in the absence of transfection reagent. 40 pmol of the peptide conjugated assemblies, or assembly lacking peptide, was added to HEK293T cells that had been transiently transfected with the T7_pEF/myc/cyto expression construct. Cells were lysed 18 hours later and assayed for RT-PCR activity as described above. The results indicate that cellular uptake of the peptide assemblies occurs and that RT-PCR as a result of cytoplasmic T7 polymerase activity on those complexes can be readily measured (FIG. 14, bottom panel). While the control assembly appears to have gained cytoplasmic entry as well, the RT-PCR activity from these control templates is considerably lower than that for the CPP assemblies.

### Example 8

### Synthesis of a Peptide-dsDNA Construct for Delivery into Cells Expressing T7 RNAP

Phosphorylated oligo HP: 5′-(phosphate) TCC TG GCTGAGG CGA GAG TT (dT-C6-NH) TT CTC TCG CCTCAGC CA GGA CC-3′ (SEQ ID NO: 12) was synthesized by IDT DNA. The DNA folds into a hairpin with an overhang, and contains a cleavage site CCTC AGC for restriction enzyme BbvCI or nicking versions of this enzyme Nb.BbvCI or Nt.BbvCI (New England Biolabs, Inc.), which can cleave either the top or bottom strand. In the middle of the hairpin loop, the side chain C5-aminomodified dT is inserted (dT-C6-NH, C6 referring to a carbon 6 linker), which was used for the coupling of the amino-PEG linker (PEG2000, approximately 45 ethylene glycol units).

Ten nanomoles of the oligo ‘HP’ were dissolved in 50 μl water. A 20-fold molar excess of Fmoc-amino-PEG2000-carboxyl-NHS ester (Jen-Kem) was dissolved in 50 μl DMF and was added to the oligo solution in 2 portions during a 2-hour time period at room temperature (final solvent composition 50% DMF/50% water). Subsequently, 60 μl of 1 M Tris HCl, pH 7.0 (final concentration of 200 mM), was added to quench the excess of NHS esters. The solution was incubated for an additional 30 minutes at room temperature. The resulting reaction mixture was diluted to 500 μL with water and was desalted by passing through a NAP-5 column (Sephadex-25, GE).

The resulting material was lyophilized and dissolved in 100 μl water. 20 μl of piperidine (20% final) was added and incubated for 2 hours at room temperature. A cloudy precipitate was formed due to deprotection of the amine and release of the water insoluble Fmoc group. The reaction then was filtered through 0.2 μm spin-filters (Millipore) and precipitated from 300 mM sodium acetate by the addition of 3 volumes of ethanol. Due to high coupling efficiency, the resulting headpiece HP-1 was used without further purification.

A model compound 5-(4,6-dichlorotriazinylaminofluorescein (DTAF) (Anaspec) was coupled to the amino group of the HP-1. DTAF structurally represents a trichlorotriazine scaffold with one amino compound coupled. To form a library, trichlorotriazine scaffolds can be derivatized with a diversity of building blocks at each of the three chlorine positions. It also provides a fluorescent label to the model library. The reaction (10 μl) was set up as follows: to 5 μl of 400 uM HP-1, dissolved in water, 2 μl of 750 mM borate buffer, pH 9.5, and 1 μl of DMF were added. DTAF was dissolved in DMF to 50 mM and 2 μl was added to the reaction. Final concentrations of the HP-1 and DTAF were 200 μM and 10 mM, respectively (50× excess of DTAF). The final DMF concentration was 30%. It was noticed that the HP-1 stays soluble in up to 90% DMF, suggesting it may be soluble in organic solvents, such as DMF. The reaction was allowed to proceed at 4° C. for 16-20 hours. The reaction mixture was then diluted with water to 30-50 μl and desalted on a Zeba spin column (Pierce). No further purification was completed.

An arginine-rich peptide R7, H(-Arg-εAhx)₆-Arg-OH (Bachem) was chosen to use as a modification for the last chorine reactive group on the triazine scaffold. This is an arginine-aminohexanoic acid cell membrane permeable peptide used for intracellular compound delivery. The reaction was set up similar to above: 20 μl reaction contained around 200 pmoles of HP-1-DTAF (step 1) dissolved in 150 mM borate buffer, pH 9.5, and 10 nmol of R7 peptide. Under these conditions, side chains of arginines do not react, while the only reactive amine in the peptide is the N-terminus. The reaction was allowed to proceed for 12 hours at 75° C. and was purified by desalting on a Zeba spin column.

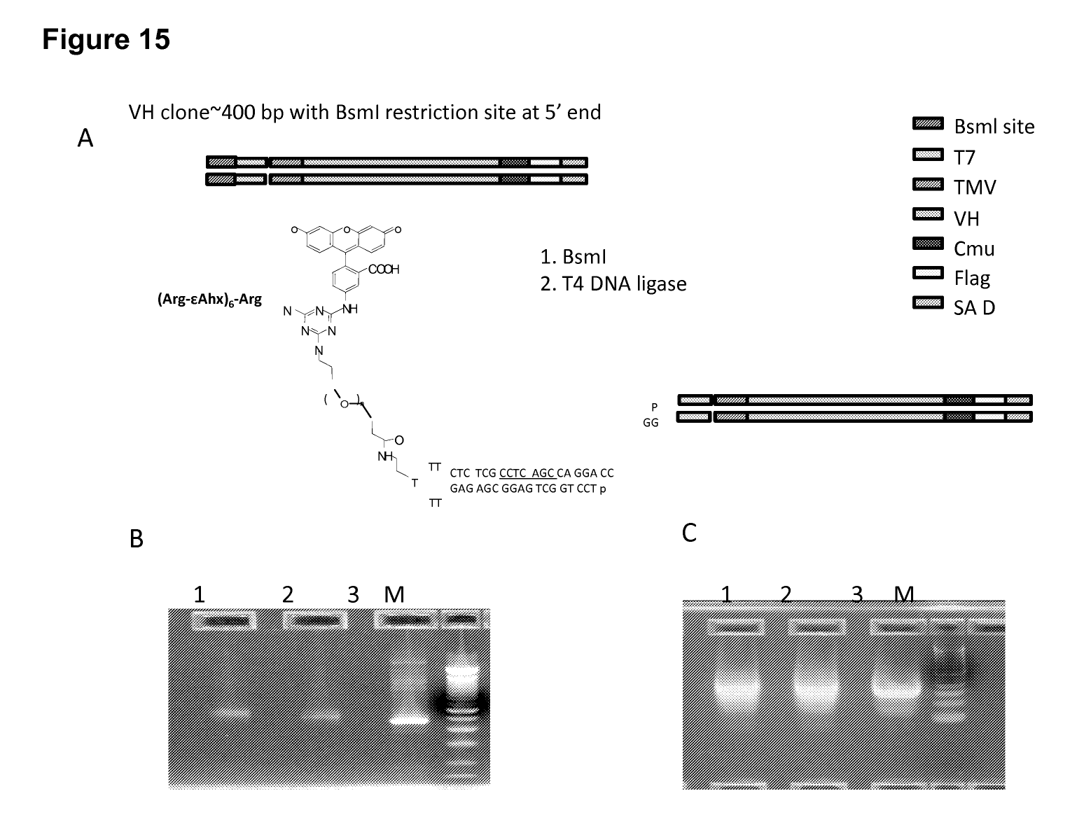

The V_{H} DNA construct used for the intracellular delivery experiment was prepared from a PCR product of a V_{H} DNA single clone of ˜400 bp featuring a T7 promoter region at the 5′ end and a Cmu region close to 3′ end of the molecule. In order to link the V_{H} DNA construct to the modified headpiece of the model chemical library, a BsmI restriction site was appended upstream of the T7 promoter region by PCR amplification of the clone. BsmI restriction digest produces a 3′ GG overhang, which allows ligation to the headpiece (3′ CC overhang). The 5′ primer with BsmI site (underlined) was synthesized by IDT DNA: 5′-GGATGCC GAATGCC TAATACGACTCACTATA GGG ACAATTACTATTTACAATTACA (SEQ ID NO: 13). Following the PCR amplification, the VH DNA construct was purified using a PCR purification kit (Invitrogen), and the resulting DNA was digested with 250 U BsmI (NEB) at 65° C. in NEB Buffer 4 for 2 hours. The DNA was purified on a 2% agarose gel. The ligation reaction (30 μl) contained 2 μmol of each V_{H} DNA construct, digested with BsmI, as well as HP-1-DTAF-R7 (arginine-aminohexanoic acid peptide) in 1× T4 DNA ligase buffer and 60 Weiss units of T4 DNA ligase (NEB). The reaction was incubated at 16° C. for 20 hours. Due to high efficiency of the ligation, the material was further used for an intracellular delivery/T7 RNAP experiment without further purification. The results are summarized in FIG. 15.

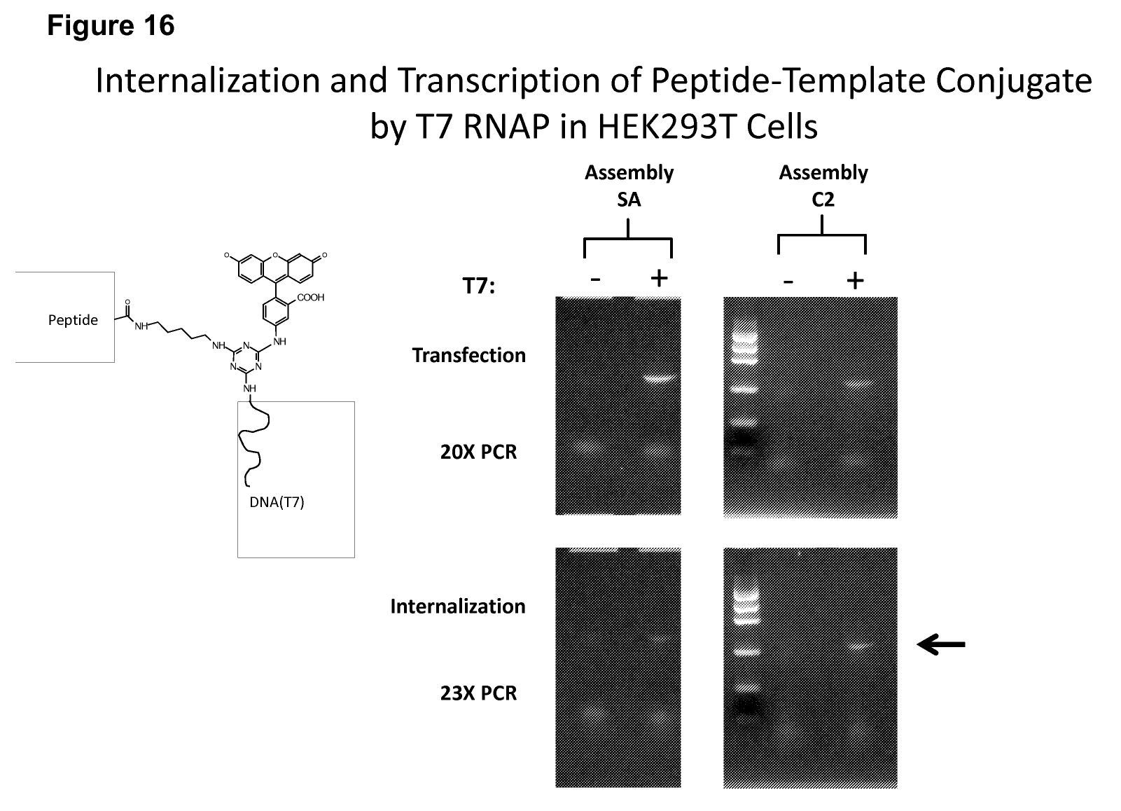

In parallel to the experiments described above, a cell penetrating small molecule C2 ligated with the V_{H} DNA through a DNA linker showed similar results by both transfection and transfection-independent cytoplasmic entry (FIG. 16).

### Example 9

### Clonal Derivation for High-Activity T7 Polymerase Cell Lines

To isolate clonal cell lines that possess higher T7 polymerase activity than the polyclonal populations, a T7-fluorescent reporter construct is engineered and introduced into prostate carcinoma polyclonal stable cell lines, as described above, by either transfection or viral infection. Those cells with the highest level of T7 polymerase activity will produce the most fluorescence and will be captured by a Mo-Flo single cell sorting FACS machine as single cell populations. Individual clonal cell lines will then be screened for fluorescence, and the cells with highest T7 activity as reported by FACS will then be screened secondarily in an RT-PCR assay.

### Example 10

### Functional Selection of High Affinity V_{H}/Peptide Reagents for Nucleic Acid Delivery

One application of the system described herein is the identification of high affinity V_{H}/peptide/small molecule reagents for nucleic acid delivery through functional cell-based selections. A DNA library encoding V_{H}/peptides carrying SP6 and T7 promoters is transcribed to an RNA library with SP6 transcriptase and ligated to a biotinylated streptavidin (SA) display linker. SA will then be loaded onto ligated RNA and assembled with another biotinylated linker with a puromycin-like molecule on the 3′ end. The assembled V_{H}/peptide library is in vitro translated to form a fusion of RNA library and their encoded V_{H}/peptides. Oligo dT purification, reverse transcription, RNaseH digestion, and second strand cDNA synthesis is performed as described herein. For specific target-mediated cell entry, the purified dsDNA-V_{H}/peptide fusion library is counter-selected by contacting it multiple times with a matched negative cell line lacking target expression to remove background binders. A pre-cleared DNA fusion library will be contacted with target-expressing cells and allowed to bind, enter cells, and access the cytoplasm irrespective of the mechanism of internalization. The cells are washed to remove non-specific binders, and the cell surface non-internalized binders are stripped off. Only those library members entering the cytoplasm are recognized and transcribed by T7 RNAP. Library members that access the cytoplasm and that are transcribed by T7 polymerase are recovered by RT-PCR, applying the conditions defined by the proof of concept experiments outlined above. The enriched binders are subjected to the next round of selection. Through multiple rounds of selection and enrichment, a cytoplasmic entry pool is generated and mediators identified through subcloning and sequencing of the enriched population using standard methods known in the art.

In one embodiment, as additional criteria for identifying cells that harbor molecules delivered into the cell, a biotinylated siRNA is assembled with the SA to generate a complex of DNA, SA, VH/peptide, and siRNA. Because SA has 4 binding sites, each component can be added at a 1:1 molar ratio with SA to load each of the binding sites with reagents of interest. The complex is screened for targeted gene mRNA knockdown and inhibition of the target gene mediated cell function as a functional readout.

In addition to target-specific selection, the approach outlined above is also applied to identify cell-specific cytoplasmic entry vehicles by using positive and negative cell lines that constitute different cellular origins or states (e.g., liver cells as a counter-selection cell type and cardiomyocyte as a positive cell type; a non-transformed cell type for counter-selection and a transformed cell type for positive selection; or an undifferentiated cell for counter-selection and a differentiated cell for positive selection). Alternatively, the cytoplasmic entry selection is applied to a given cell type without counter selection approaches to isolate delivery vehicles that might target multiple cell types or cell surface targets.

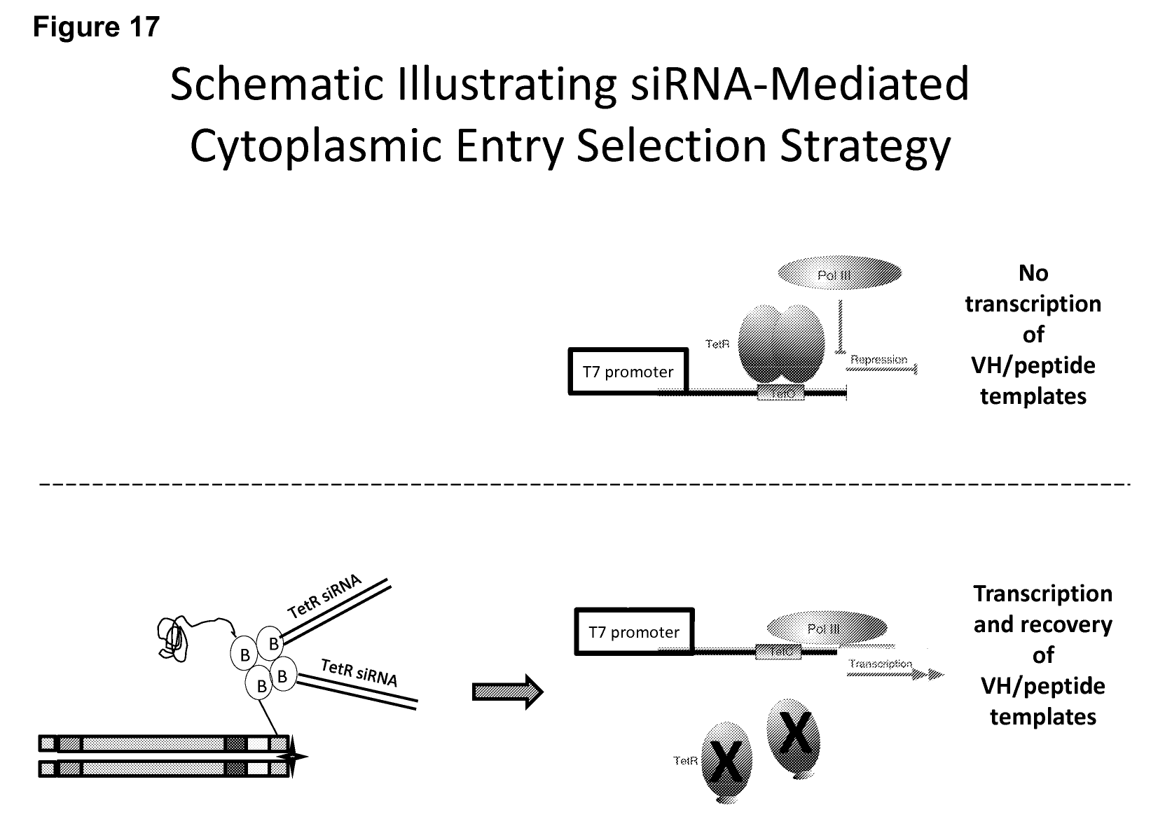

The cytoplasmic entry selections are further refined to utilize mRNA knockdown mediated by an oligonucleotide (e.g., siRNA, miRNA, transcription factor/repressor titration, or antisense oligonucleotides) delivery as the selective pressure. A tetracycline-regulated T7 polymerase gene is introduced into cell lines of choice along with the Tet repressor protein cDNA (TetR). The biotin:streptavidin library complex then includes biotinylated DNA-encoding peptide/V_{H}+streptavidin+biotinylated peptide/V_{H}+biotinylated siRNA for the TetR mRNA (FIG. 17). If any library member gains access to the cytoplasm and the siRNA gains access to the RSC complexes involved in mRNA degradation, then the TetR mRNA is eliminated, resulting in the loss of TetR protein and the induction of T7 polymerase activity. V_{H}/peptides that mediate cytoplasmic uptake are then transcribed by T7 and subsequently amplified and recovered by RT-PCR.

### Example 11

### In Vivo Selection of Nucleic Acid Delivery Vehicles

Identification of agents that mediate in vivo delivery of nucleic acids is accomplished by generating transgenic mice that carry cytoplasmic polymerases. For example, a transgenic mouse is generated that expresses T7 RNAP. dsDNA libraries are subsequently delivered to the mouse using standard delivery techniques (e.g., tail vein injection). Tissues or cells are isolated following injection and lysed. RNA is isolated and subjected to RT-PCR, subcloning, and sequencing to identify the encoded molecule that mediated entry into the desired tissue and/or cell. In some cases, the process is repeated to enrich for species that gain entry. Following the identification of the species, the molecule of interest is attached to any form of nucleic acid, protein, or small molecule to test for tissue and/or cell-specific delivery.

### Example 12

### Identification of Members of Nucleic Acid Display Library Using DNA Methyltransferase

dsDNA libraries are prepared containing optimized binding sites for PCR primers for DNA methylation. The dsDNA library is incubated with cells overexpressing DNA methyltransferase (DNMT1), and specific library members are allowed to internalize into certain cells. Upon entry into the cytoplasm, the dsDNA tags from the library become a substrate for DNMT1 and, thus, are selectively methylated. The cells are subsequently lysed, and the dsDNA tags are isolated and treated with sodium bisulfite using standard protocols for methylation specific PCR (Herman et al., Proc. Natl. Acad. Sci. USA 93: 9821-9826 (1996)). The dsDNA tags that are methylated are then selectively amplified using methylation specific primers. Following PCR, the DNA product is sequenced, allowing for the identification of molecules from the library that mediated selective uptake into the cytoplasm of the cells.

### Example 13

### ssRNA Aptamer Library

A ssRNA aptamer library (unmodified or modified bases, as known in the art) is prepared containing a polymerization site for ssRNA-dependent RNA polymerase (e.g., polioviral 3Dpol, vesicular stomatitis virus L, and hepatitis C virus NS5b protein). The ssRNA aptamer library is incubated with cells overexpressing the ssRNA dependent RNA polymerase, and specific library members are allowed to internalize into certain cells. Upon entry into the cytoplasm, the library member becomes a substrate for the polymerase. RNA is harvested from the cells, and specific primers for the resultant RNA product of the polymerization reaction are used to reverse transcribe, PCR, and sequence the molecule(s) that gained entry into the cell.

### Other Embodiments

All publications, patents, and patent applications mentioned in the above specification are hereby incorporated by reference. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

What is claimed is:

1. A composition comprising a nucleic acid display library, wherein members of said nucleic acid display library are linked to a molecule that generates an intracellular readout signal.

2. The composition of claim 1, wherein members of said nucleic acid display library are linked to a streptavidin molecule and wherein said streptavidin molecule is further linked to a molecule that generates an intracellular readout signal.

3. The composition of claim 2, where the molecule that generates an intracellular readout signal is a nucleic acid, protein, peptide, or small molecule.

4. The composition of claim 3, wherein said nucleic acid molecule that generates an intracellular readout signal encodes a reporter gene, a transcription factor gene, RNA, or an antisense gene.

5. The composition of claim 3, wherein said protein is green fluorescent protein (GFP).

6. The composition of claim 3, wherein said small molecule is a fluorophore.

7. The composition of claim 1, wherein nucleic acid molecules of said nucleic acid display library are expressed intracellularly.

8. The composition of claim 7, wherein the intracellular expression of said nucleic acid molecules of said nucleic acid display library is under the control of an exogenous RNA polymerase promoter.

9. The composition of claim 8, wherein said RNA polymerase is T7 RNA polymerase.

10. A composition comprising a DNA-encoded small molecule library with multimeric small molecule species attached to members of said library via a branched linker.

11. A composition comprising a DNA-encoded small molecule library with two or more small molecules attached to the DNA of the library through the DNA bases, wherein said bases are modified with a linker species.

12. A method for the identification of a molecule that facilitates the intracellular delivery of a nucleic acid, wherein said molecule is linked to a member of a nucleic acid display library and said member of said nucleic acid library is further linked to a gene, said method comprising contacting cells with said nucleic acid display library and identifying a member of said nucleic acid display library linked to said molecule that facilitates the delivery of said nucleic acid into said cells by monitoring expression of said gene linked to member of said nucleic acid library.

13. The method of claim 12, wherein expression of said gene linked to a member of said nucleic acid library is under the control of an exogenous RNA polymerase promoter.

14. The method of claim 12, wherein said cells express RNA polymerase in the cytoplasm of said cell.

15. The method of claim 14, wherein said RNA polymerase is T7 RNA polymerase.

16. The method of claim 12, wherein said cells express one or more enzymes capable of modifying members of said nucleic acid library that are delivered intracellularly.

17. The method of claim 16, wherein said enzyme is DNA methyltransferase.

18. The method of claim 17, wherein said DNA methyltransferase selectively methylates members of said nucleic acid display library that are delivered intracellularly.

19. A method for the identification of a molecule that facilitates the intracellular delivery of a nucleic acid, wherein said molecule is linked to a member of a nucleic acid display library and said member of said nucleic acid library is further linked to a RNA polymerase binding site, said method comprising contacting said cells with said nucleic acid display library and identifying a member of said nucleic acid display library linked to said molecule that facilitates the delivery of said nucleic acid into said cells by monitoring and decoding intracellular transcription of a nucleic acid portion of said members of said nucleic acid library, wherein an RNA polymerase present in said cell catalyzes said transcription.

20. The method of claim 19, wherein said RNA polymerase is T7 RNA polymerase.

21. The method of claim 12, wherein said molecule is a nucleic acid molecule.

22. The method of claim 21, wherein said nucleic acid molecule is RNAi, miRNA, an antisense nucleic acid molecule, or a gene.

23. The method of claim 12, wherein said molecule is a protein.

24. The method of claim 12, wherein said molecule is a peptide.

25. The method of claim 12, wherein said molecule is a small molecule.

26. A method for the identification of a first molecule that facilitates the intracellular delivery of a second molecule, wherein said first and second molecules are linked to a member of a nucleic acid library, said method comprising contacting said cells with said nucleic acid display library and identifying members of said nucleic acid display library linked to said first molecule that facilitate the delivery of said second molecule into said cells by monitoring the modification of members of said nucleic acid library by one or more enzymes present in said cell.

27. The method of claim 26, wherein said first or second molecule is a nucleic acid molecule.

28. The method of claim 27, wherein said nucleic acid molecule is RNAi, miRNA, an antisense nucleic acid molecule, or a gene.

29. The method of claim 26, wherein said molecule is a protein.

30. The method of claim 26, wherein said molecule is a peptide.

31. The method of claim 26, wherein said molecule is a small molecule.

32. The method of claim 12, where said nucleic acid display library is a dsDNA display library.

33. The method of claim 32, wherein said dsDNA display library is a CIS display library, a puromycin-mediated dsDNA display library, a CDT display library, dsDNA libraries attached to small molecules, and streptavidin display libraries.

34. The composition of claim 1, where said nucleic acid display library is a dsDNA display library.

35. The composition of claim 34, wherein said dsDNA display library is a CIS display library, a puromycin-mediated dsDNA display library, a CDT display library, dsDNA libraries attached to small molecules, and streptavidin display libraries.
